(19) United States
(12) Patent Application Publication
(10) Pub. No.: US 2019/0047191 A1
(43) Pub. Date: Feb. 14, 2019

(54) Injection-Molded Component with Insert Part, Method for Producing Same, and Uses Thereof

(71) Applicant: PlasmaTreat GmbH, Steinhagen (DE)

(72) Inventors: Christian Buske, Bielefeld (DE); Artur Grishin, Steinhagen (DE); Kay Fehling, Bad Salzuflen (DE); Alexander Knospe, Bad Muender (DE)

(21) Appl. No.: 16/071,584

(22) PCT Filed: Jan. 25, 2017
(86) PCT No.: PCT/EP2017/051483

§ 371 Date: Jul. 20, 2018

(30) Foreign Application Priority Data
Jan. 27, 2016 (DE) 10 2016 101 456.7
Oct. 19, 2016 (DE) 10 2016 119 913.3

(51) Int. Cl. B29C 45/14; H05H 1/42; H05H 1/48

(52) U.S. Cl. CPC B29C 45/14311; H05H 1/42; H05H 2245/123; B29C 2045/14885; H05H 1/48

(57) ABSTRACT

The invention relates to a method for producing an injection-molded component with an insert part. An insert part is provided with an inorganic surface, and the insert part is at least partly overmolded during the injection-molding process. The region, which is overmolded during the injection-molding process, of the inorganic surface of the insert part is coated at least in some regions prior to being overmolded, wherein the inorganic surface is supplied with an atmospheric plasma beam and a precursor. The invention further relates to an injection-molded component with an insert part, said insert part having an at least partly overmolded inorganic surface. A layer which is applied by means of a plasma coating process, in particular a plasma polymerization process, is arranged at least in some regions between the inorganic surface and the overmolded plastic.

The invention relates to an injection-moulded component with insert and to a method for producing such an injection-moulded component with insert. The invention also relates to advantageous uses for such an injection-moulded component.

Electrical components are overmoulded in the injection moulding process for better manageability, for insulation and for protection against environmental influences. When producing such an injection-moulded component, the electrical component is arranged as an insert at the desired position in an injection mould. Then, the liquid plastic is fed into the injection moulding tool. After the plastic has hardened, the electrical component is embedded in the plastic and is protected.

It has become apparent that in the case of inserts having an inorganic surface, in particular electrical components consisting of metal or having a metal surface, it is difficult to obtain a bond between the surface of the insert and the plastic which is media-tight and has long-term durability. In particular, it became apparent that the connection between the surface of the insert and of the plastic can be easily infiltrated by water or organic solvents, such as oil or petrol, so that such media can reach the interior of the injection-moulded component and impair the functioning of it, in particular by corroding the insert.

Attempts have been made to coat the surface of the insert with chemical primer solutions, in order to obtain a better adhesion between the surface and the plastic. However, this is very intricate in terms of the process, difficult to automate and cost-intensive. In addition, primer systems available on the market are generally environmentally harmful and have often proved to be not sufficiently resistant to corrosion.

Against this background, the present invention is based on the object of providing a media-tight injection-moulded component with insert and a reliable and economic method for producing it.

In a method for producing an injection-moulded component with insert, in which an insert is provided with an inorganic surface, and in which the insert is at least partly overmoulded in the injection moulding process, this object is at least partly achieved according to the invention in that the area of the inorganic surface of the insert which area is overmoulded during the injection moulding process is at least in certain areas coated prior to being overmoulded by impinging the inorganic surface with an atmospheric plasma beam and a precursor.

It has become apparent that a layer applied using an atmospheric plasma beam is particularly well suited for producing a connection between the inorganic surface of the insert and the plastic which has long-term durability and is media-tight. Tests have in particular shown that layers produced in such a way are particularly corrosion-resistant and media-resistant, so that infiltration of the connection between the surface and the plastic by wetness, oil or organic solvents, such as petrol, is eliminated or prevented. In addition, such an atmospheric plasma coating can be easily integrated and automated in a production process, so that the proposed method can be implemented in an economic way. Finally, the intricate, expensive and environmentally harmful primer solutions from the prior art can also be avoided with the described method.

The insert has an inorganic surface. A firmly bonded connection which has long-term durability between an inorganic surface and a plastic is generally not easily possible. By means of the atmospheric plasma coating of the surface, a good connection can even be obtained in the case of inorganic surfaces.

The inorganic surface may in particular be a metal surface, a glass surface or a ceramic surface. Particularly with a metal surface, good results with regard to the corrosion resistance and media tightness of the connection between the surface and the plastic were obtained by means of the atmospheric plasma coating. Bronze, an aluminium alloy, a brass alloy, a copper alloy, a stainless steel, a carbon steel or a galvanised steel come into consideration as the metal, for example.

The insert can, for example, essentially consist of inorganic material, for example metal, or have at least one component consisting of the inorganic material, which has an inorganic surface. The insert can also be coated with an inorganic material, for example a metal, so that an inorganic surface results.

The insert is at least partly overmoulded in the injection-moulding process. Overmoulding is understood to mean that the insert is at least partly embedded in plastic during the injection-moulding process. For this purpose, the insert is in particular arranged at the desired place in an injection mould, into which then liquid or softened plastic is injected. After the plastic has solidified or hardened, the insert is at least partly enclosed by the plastic or embedded in it.

The area of the inorganic surface of the insert overmoulded during the injection-moulding process is at least in certain areas coated, in particular with an adhesion-promoting layer, preferably with an organic, in particular an organosilicon, adhesion-promoting layer, before the overmoulding takes place. The area of the inorganic surface overmoulded during the injection-moulding process is understood as the area which is covered with plastic or embedded in the plastic after the injection moulding. This area thus constitutes a contact area between the insert and the plastic. This contact area is at least in certain areas coated before the overmoulding takes place, so that the layer applied in this way can improve the connection between the inorganic surface and the plastic.

The coating is carried out by impinging the inorganic surface with an atmospheric plasma beam and a precursor. A plasma beam is understood to mean a directed, at least partly ionised gas beam. An atmospheric plasma beam is understood to mean a plasma beam operating in an environment which is essentially at atmospheric pressure. An elaborate vacuum environment is therefore not necessary.

A precursor suitable for producing an adhesion-promoting layer is in particular used as the precursor, preferably an organic, in particular an organosilicon, precursor. The precursor can be fed into the plasma beam before it strikes the inorganic surface. Alternatively, the precursor can also be applied to the inorganic surface which is then stroked over by the plasma beam.

With an injection-moulded component with insert, wherein the insert has an at least partly overmoulded, inorganic surface, the above mentioned object is also at least partly achieved according to the invention in that a layer applied by plasma coating, in particular plasma polymerisation, is arranged at least in certain areas between the inorganic surface and the overmoulded plastic. The injection-moulded component with insert is preferably producible or produced using the previously described method.

The layer applied by means of the plasma coating results in a connection between the insert and the plastic which is has long-term durability and is media-tight, so that in this way a media-tight injection-moulded component is provided.

In addition, the above mentioned object is at least partly achieved according to the invention by the use of the previously described injection-moulded component or an embodiment thereof for application in an environment which is wet and contains solvents, in particular in a vehicle, for example in a motor vehicle or in an aircraft.

Due to the higher long-term durability and media-tightness of the connection between the inorganic surface of the insert and the overmoulded plastic, the injection-moulded components are particularly suitable for areas of application in which components are subjected to particular corrosion or media stresses by the environment. This is particularly the case in motor vehicles. For example, exposed injection-moulded components can be subjected to wetness and splash water. The injection-moulded components described here can also be used inside coolant-, lubricant- or fuel-carrying components, since the durability and media-tightness prevent premature damage to or destruction of the components by the penetration of coolants, lubricants or fuels.

Different embodiments are described below, which in each case apply both to the method for producing an injection-moulded component and to the injection-moulded component itself as well as its use. The different embodiments can also be combined with one another.

In a first embodiment of the method, the insert is only partly overmoulded in the injection moulding process, so that an area of the insert is exposed after the injection moulding. In a corresponding embodiment of the injection-moulded component, the insert is only partly overmoulded, so that an area of the insert is exposed. The exposed area can, for example, be a connection area for connecting the insert to other components. For example, with a plug a plug pin is exposed, so that this can be inserted into a socket. Due to the exposed area of the insert there is a likewise exposed transition between the insert and the plastic which can be infiltrated by wetness or other media when the connection is not sufficiently media-tight. Therefore, the method described here or the injection-moulded component described here is particularly suitable for protecting such a transition area.

In a further embodiment, the insert is an electrical component. An electrical component is here understood to mean a component carrying current in operation. The electrical component can be a simple conductor or a more complex electronic component, for example with a microchip. Electrical components are particularly sensitive to wetness or aggressive media, such as oils or solvents. Such components are particularly protected by the media-tightness obtained by means of plasma coating, so that the injection-moulded components have a longer operating life or can be used in more adverse environments, for example with high levels of wetness.

The insert can in particular comprise a plug element to be overmoulded, a sensor to be overmoulded or a conductor structure to be overmoulded, in particular a lead frame.

The plug connection element can in particular be a plug pin or a plug socket which is overmoulded with plastic. Since the plug connection element is provided for connecting to a corresponding plug connection element, for example a plug pin for connecting to a corresponding plug socket, the plug connection element is only partly overmoulded with plastic, while a part of the plug connection element is exposed, in order to enable a plug connection to be established. Infiltration of the plastic casing, in particular from the exposed side of the plug connection element, can be prevented by the layer on the surface of the plug connection element applied by means of the plasma coating.

The sensor can in particular be a sensor with an exposed area, i.e. with an area which is not embedded in the plastic. In this way, the sensor can directly make contact with its surroundings and in this way measure information concerning the surroundings without being hindered by a plastic layer. For example, the sensor can be a temperature sensor or an optical sensor. Infiltration of the plastic casing of the sensor, in particular from the exposed area of the sensor, is prevented by the layer applied by means of the plasma coating, so that the sensor, which is typically particularly sensitive to wetness and aggressive media, is protected.

The conductor structure can, for example, be a lead framework of a circuit with a plurality of electrical contact points for connecting electrical components and with a plurality of lead connections which electrically connect the contact points to one another. Such a lead framework is overmoulded in the injection moulding process in particular in such a way that at least some of the electrical contact points remain exposed, so that electrical components can be connected to the contact points. Such overmoulded lead frameworks are, for example, used in motor vehicles in order to interconnect pre-fabricated electrical components to form a circuit.

The conductor structure can in particular also be a lead frame. A lead frame is understood as a metallic lead carrier in the form of a frame or comb which is used for producing chip packages of microchips or other electrical components.

In a further embodiment, the inorganic surface is pre-cleaned before the coating, in particular it is plasma pre-cleaned, preferably by impinging it with an atmospheric plasma beam. For example, the inorganic surface can firstly be pre-cleaned with the atmospheric plasma beam without adding a precursor and then coated by adding a precursor. A better and more uniform coating of the inorganic surface can be obtained by means of the plasma pre-cleaning.

In a further embodiment, the atmospheric plasma beam is generated using a plasma nozzle, wherein the plasma nozzle has a nozzle opening, out of which the plasma beam emerges in operation. In this way, the direction of the plasma beam can be set by the alignment of the plasma nozzle, so that a pinpoint impingement of the inorganic surface of the insert is made possible. In particular, it is also in this way possible to coat the inorganic surface of the insert in a predefined area. Furthermore, the relative positioning of such a plasma nozzle in relation to the insert can be automated well, so that an efficient production flow is made possible.

In a further embodiment, the atmospheric plasma beam is generated by means of an arc-like discharge in a working gas, wherein the arc-like discharge is generated by applying a high-frequency high voltage between electrodes. Preferably, nitrogen is used as the working gas. A high-frequency high voltage is typically understood as a voltage of 1-100 kV, in particular 1-50 kV, preferably 10-50 kV, at a frequency of 1-300 kHz, in particular 1-100 kHz, preferably 10-100 kHz, more preferably 10-50 kHz. In this way, a plasma beam can be generated which can be focussed well and is additionally well suited to plasma coating. In particular, a plasma beam generated in such a way has a relatively low temperature, so that damage to the insert can be prevented.

In a further embodiment, the precursor is fed into the plasma beam. A plasma nozzle with an integrated precursor feed can, for example, be used for this purpose. The precursor can, for example, be fed into the plasma beam in the area of the nozzle outlet of the plasma nozzle. The precursor can be chemically activated by the interaction of the precursor with the plasma beam, so that it forms a thin and uniform layer on the inorganic surface. In particular, the plasma beam can bring about a polymerisation of the precursor, so that the molecules of the precursor cross-link with one another and thereby form a cross-linked layer on the inorganic surface. The introduction of the precursor into the plasma beam also has the advantage that the precursor fragments and can be uniformly distributed on the surface.

A device for generating an atmospheric plasma beam for treating the surface of a workpiece is known from EP 1 230 414 B1, in which a precursor is introduced into the area of the plasma beam. The precursor can be introduced into the plasma beam in the nozzle opening itself or in the area downstream of the nozzle opening. The precursor then reacts within the plasma and forms a reaction product which is deposited on the surface to be treated. Surfaces can be uniformly coated by means of plasma coating in this way.

The precursor material is preferably introduced into the plasma beam in the gaseous state. In addition, the precursor can also be fed in in a liquid state, dissolved or dispersed in a fluid, or in a solid, preferably powdery, state. In this case, the precursor material only evaporates or melts in the reaction zone of the plasma beam.

In a further embodiment, an organic precursor, preferably an organosilicon precursor, in particular an organosilicon-functionalised precursor, is used as the precursor.

Possible precursors are: organosilicon compounds, such as hexamethyldisiloxane or tetraethoxysilane, but also functionalised organosilicon compounds with an epoxide group such as 3-glycidoxypropyltrimethoxysilane, with an acrylate group such as γ-methacryloxypropyltrimethoxysilane, with an amino group such as 3-aminopropyltrimethoxysilane, 3-aminopropyltriethoxysilane or [3-(2-aminoethyl)aminopropyl]trimethoxysilane, with a vinyl group such as vinyltrimethoxysilane or 1,3-divinyltetramethyldisiloxane, with thiol groups such as (3-mercaptopropyl)trimethoxysilane or sulphane groups such as Bis [3-(triethoxysilyl)propyl]tetrasulphide. In addition, purely organic thus aliphatic, cyclic and aromatic precursors can also be used, such as heptane, 1-hexene, 1-octene, 1-heptine, 1,7-octadiene, 1,5-hexadiene, 1,5-cyclooctadiene, toluene and xylenes.

A particularly preferred precursor is γ-methacryloxypropyltrimethoxysilane, with which good adhesion-promoting properties were obtained.

Furthermore, a mixture consisting of a plurality of the above named compounds can also be used as the precursor.

The previously described precursors have proved particularly suitable for providing a connection between the inorganic surface and the overmoulded plastic which has long-term durability and is media-tight.

In a further embodiment, the insert is overmoulded with a thermoplastic, in particular polyamide (PA), polybutylene terephthalate (PBT), polyethylene terephthalate (PET), polycarbonate (PC), a liquid crystal polymer or mixtures thereof, such as a mixture of polyamide and polycarbonate. Particularly good results with regard to corrosion resistance and media-tightness were obtained with polyamide, in particular with PA6, PA66 and PA66/6, in combination with an insert of metal and the layer applied by means of atmospheric plasma coating.

Instead of thermoplastics, it is also conceivable for the insert to be overmoulded with a thermosetting plastic, for example with a polyurethane or an epoxy resin.

In a further embodiment, the injection-moulded component is designed for application in an environment which is wet or contains solvents, in particular in a vehicle, in particular in a motor vehicle or in an aircraft. For example, the injection-moulded component can be a sensor which is to be placed in a medium, such as a cooling medium, lubricant medium or fuel medium.

Further features and advantages of the invention result from the following description of exemplary embodiments, in which reference is made to the attached figures.

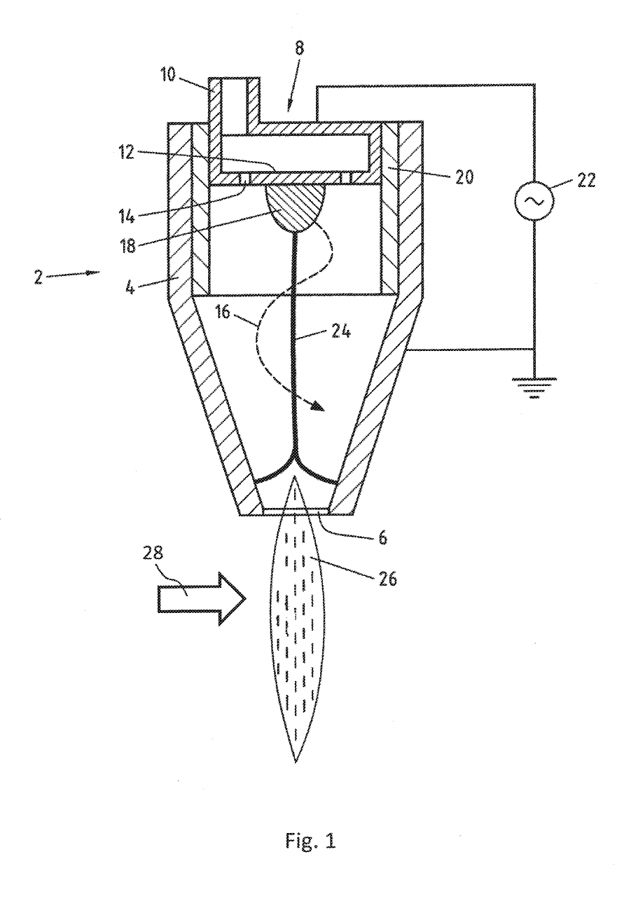

FIG. 1 shows an exemplary embodiment for a plasma nozzle which can be used for the method,

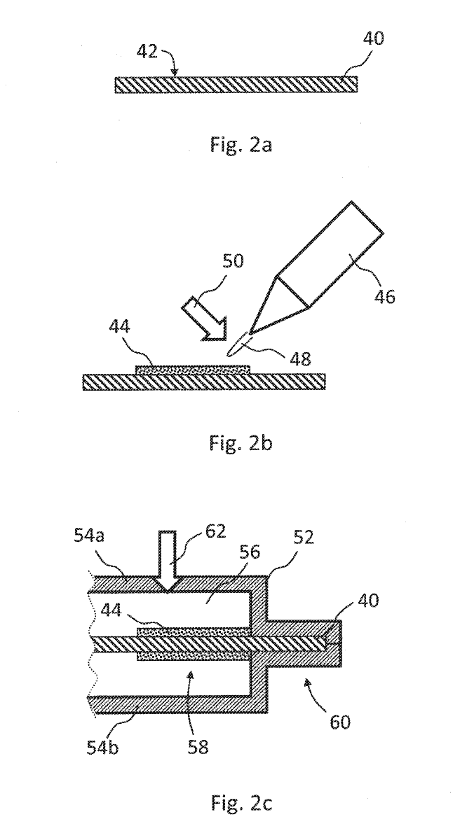

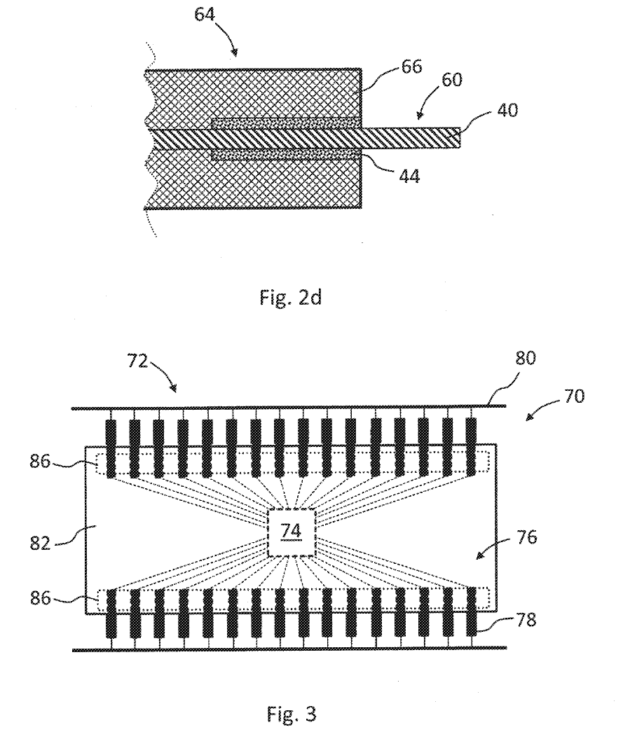

FIGS. 2a-d show an exemplary embodiment of the method for producing an injection-moulded component with insert and an exemplary embodiment of the injection-moulded component with insert,

FIG. 3 shows a further exemplary embodiment of the injection-moulded component with insert,

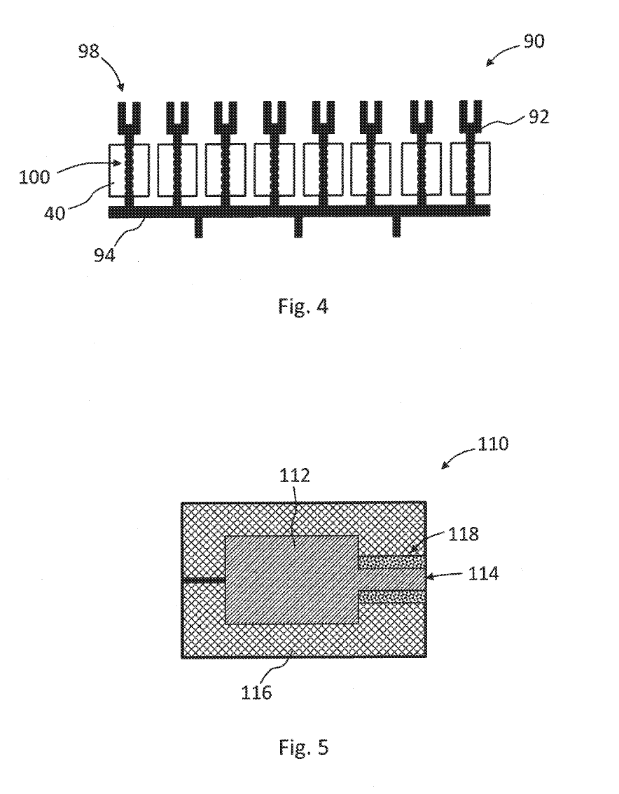

FIG. 4 shows a further exemplary embodiment of the injection-moulded component with insert,

FIG. 5 shows a further exemplary embodiment of the injection-moulded component with insert,

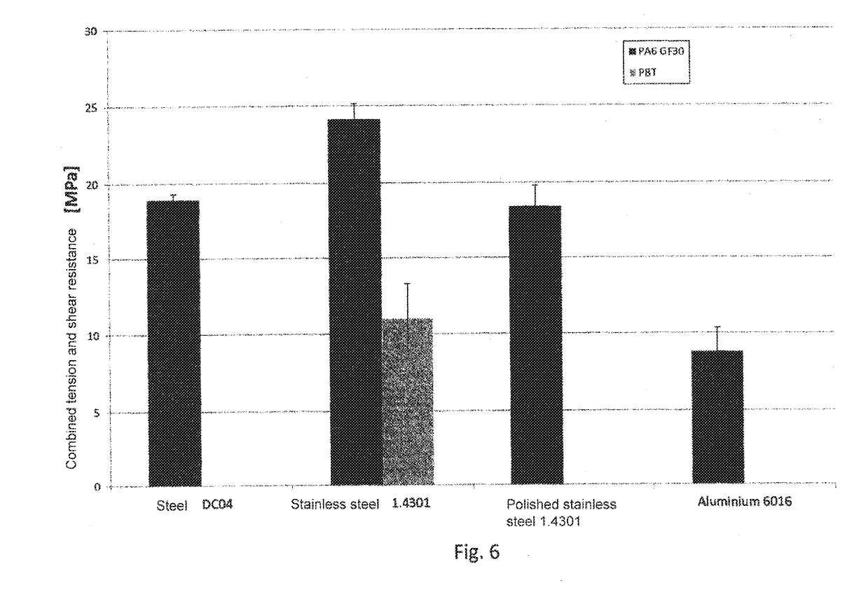

FIG. 6 shows a diagram with results of shear tension tests on injection-moulded components and

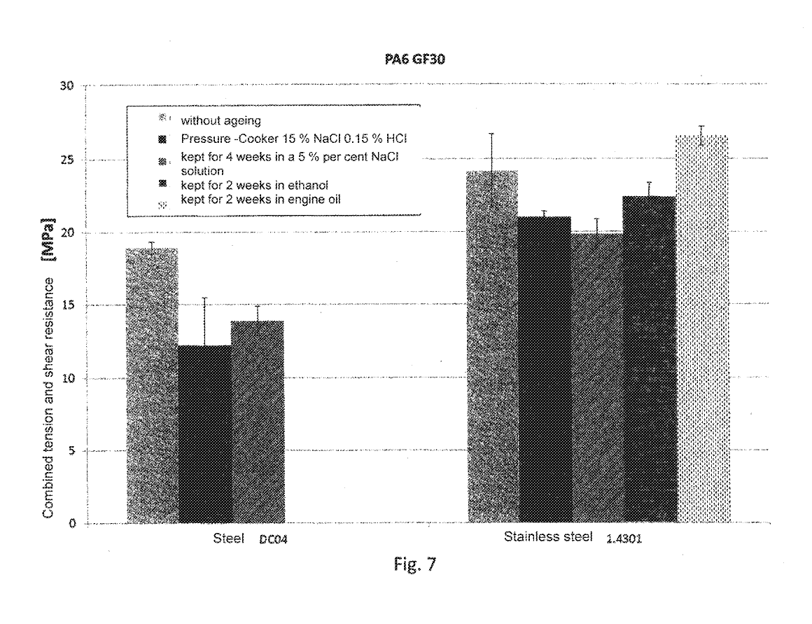

FIG. 7 shows a diagram with results of shear tension tests on injection-moulded components after ageing in various media.

FIG. 1 firstly shows, in a schematic sectional view, a plasma nozzle which can be used in the described method for producing an injection-moulded component with insert.

The plasma nozzle 2 has a nozzle tube 4 consisting of metal which tapers towards a nozzle opening 6. At the end opposite the nozzle opening 6 the nozzle tube 4 has a swirling device 8 with an inlet 10 for a working gas, for example for nitrogen.

An intermediate wall 12 of the swirling device 8 has a ring of holes 14 which are positioned obliquely in the circumferential direction and through which the working gas is swirled. The working gas hence flows through the downstream, tapered part of the nozzle tube in the form of a vortex 16, the core of which runs on the longitudinal axis of the nozzle tube. An electrode 18 is arranged centrally on the underside of the intermediate wall 12 and protrudes coaxially in the direction of the tapered section into the nozzle tube. The electrode 18 is electrically connected to the intermediate wall 12 and to the other parts of the swirling device 8. The swirling device 8 is electrically insulated from the nozzle tube 4 by a ceramic tube 20. A high-frequency high voltage, which is generated by a transformer 22, is applied to the electrode 18 via the swirling device 8. The inlet 10 is connected via a hose (not shown) to a pressurised working gas source with variable throughput. The nozzle tube 4 is earthed. A high-frequency discharge in the form of an electric arc 24 is generated between the electrode 18 and the nozzle tube 4 by the applied voltage.

The term “electric arc” is used here as a phenomenological description of the discharge, since the discharge occurs in the form of an electric arc. The term “electric arc” is otherwise understood in the context of direct voltage discharges with essentially constant voltage values.

Due to the swirling flow of the working gas, this electric arc is, however, channelled in the vortex core on the axis of the nozzle tube 4, so that it only branches out in the area of the nozzle opening 6 to the wall of the nozzle tube 4. The working gas, which rotates with high flow velocity in the area of the vortex core and hence in close proximity to the electric arc 24, comes into intimate contact with the electric arc and is thereby partly converted to the plasma state, so that an atmospheric plasma beam 26 emerges out of the plasma nozzle 2 through the nozzle opening 6.

In order to plasma coat a surface, the surface is impinged with the plasma beam 26 and a suitable precursor 28. The precursor 28 can in particular be introduced into the plasma beam 26. A precursor feed line, which feeds the precursor 28 into the plasma beam 26, can be arranged, for example, in the area of the nozzle opening 6 for this purpose. Such a precursor feed line can also be integrated into the plasma nozzle 2. For example, a tube with a precursor feed line can be attached to the nozzle opening 6, so that the plasma beam 26 is conducted through the tube and the precursor is introduced into the plasma beam in the tube. A precursor feed line which introduces the precursor into the interior of the nozzle tube 4 is also conceivable. The precursor can also be introduced together with the working gas through the inlet 10 into the nozzle tube 4. However, it is preferable to introduce the precursor 28 into the plasma beam 26 outside the nozzle tube 4, so that the precursor 28 is not affected by the electric arc 24 or the high temperatures within the nozzle tube 4.

The interaction of the plasma beam 26 with the precursor 28 results in an activation and possible fragmentation of the precursor 28. The activated precursor 28 then forms a uniform layer when it strikes the surface to be coated.

FIGS. 2a-d now show an exemplary embodiment of the method for producing an injection-moulded component with insert and an exemplary embodiment of the injection-moulded component with insert.

In a first step, illustrated in a schematic sectional view in FIG. 2a, an insert 40 is firstly provided. In this exemplary embodiment, the insert is a plug pin. The method can also be carried out in a corresponding manner with other inserts. The plug pin consists of metal and therefore has a metal surface as the inorganic surface 42.

It became apparent that a direct connection of the metal surface 42 to a plastic, which connection has long-term durability and is media-tight, is difficult to achieve. Therefore, in the second step, illustrated in a schematic partial sectional view in FIG. 2b, the metal surface 42 is provided with a layer 44 applied by atmospheric plasma coating. For this purpose, an atmospheric plasma beam 48 is generated using a plasma nozzle 46 and directed onto the metal surface 42. The plasma nozzle 46 can in particular be designed like the plasma nozzle 2 illustrated in FIG. 1 and the plasma beam 48 can thus correspond to the plasma beam 26.

A precursor 50 is fed to the plasma beam 48, so that it is activated by the plasma beam 48 and reaches the metal surface together with the plasma beam 48, where it forms the layer 44 by plasma polymerisation. The precursor 50 can preferably be an organic compound, in particular an organosilicon compound.

Before the plasma coating, the metal surface can optionally be subjected to plasma pre-cleaning. For example, for the pre-cleaning the metal surface can firstly just be impinged with the plasma beam 48, without the addition of the precursor 50, before the precursor 50 is added to the plasma beam 48.

In the third step shown in a schematic sectional view in FIG. 2c, the coated insert 40 is arranged in an injection mould 52. The injection mould 52 consists of two halves 54a-b which when put together enclose a cavity 56 which defines the outer form of the injection-moulded component to be produced. The insert 40 is positioned in the injection mould 52 in such a way that an overmould area 58 of the insert 40 is arranged within the cavity 56 and a connection area 60 of the insert 40 is closely encompassed by the injection mould 52, so that it lies outside the cavity 56. The overmould area 58 at least partly encompasses the area of the metal surface 42 coated with the layer 44, so that the layer 44 is at least partly arranged within the cavity 56.

During the injection moulding process, liquid plastic is injected under pressure into the injection mould 52 by means of a sprue 62, so that the plastic fills up the cavity 56. The insert 40 is thereby embedded by the plastic in the overmould area 58, wherein the layer 44 provides a good adhesion between the metal surface 42 and the plastic. The connection area 60 of the insert 40 remains free of plastic during the injection moulding process.

After the plastic has solidified, the complete injection-moulded component 64 can be removed from the injection mould 52. The complete injection-moulded component 64 is illustrated in FIG. 2d in a schematic sectional view. A connection between the insert 40 and the plastic 66, which connection has long-term durability and is media-tight, is ensured by the layer 44. In this way, infiltration of the connection between the insert 40 and the plastic 66 from the connection area 60, e.g. by wetness, oil or organic solvents, is prevented. The injection-moulded component 64 produced in this way is therefore particularly suitable for use in an environment which is wet, contains oil or solvents, for example in the engine compartment of a motor vehicle or inside a coolant, lubricant or fuel line system or tank.

FIG. 3 shows a further exemplary embodiment of an injection-moulded component 70 with insert 72 in a schematic view. The insert 72 is a lead frame for a microchip 74. The lead frame 72 comprises a conductor configuration 76 consisting of metal with a plurality of conductors which in each case lead outwards from a contact point of the microchip 74 to a solderable contact foot 78. The conductor configuration 76 is embedded in a frame 80 for better handling.

When encasing microchips, the microchip 74 is placed in the middle of the conductor configuration 76 and the contact points of the microchip are bonded with gold wires to the individual conductors of the conductor configuration 76. In order to protect the microchip from environmental influences, the microchip 74 and the conductor configuration 76 are then encapsulated with a plastic casing 82 in an injection moulding process, in which the contact feet 78 remain free. After the injection moulding, the fully encased microchip, i.e. the complete injection-moulded component 70, can be separated from the frame 80.

In order to prevent wetness or other media infiltrating the connection between the contact feet 78 and the plastic casing 82, before the injection moulding the lead frame 72 is plasma coated in the area 84 adjoining the exposed contact feet 78 by impinging this area 84 of the lead frame 72 with a plasma beam and a precursor. The layer produced in this way guarantees a connection between the conductor configuration 76 and the plastic casing 82 which has long-term durability and is media-tight.

FIG. 4 shows a further exemplary embodiment of an injection-moulded component 90 with insert 92 in a schematic view. The insert 92 is a lead frame for producing a plurality of plugs. The lead frame 92 has a plurality of conductor structures 92 which for easier handling are arranged on a comb-shaped frame 94. In order to produce the plugs, the lead frame 92 is arranged in an injection mould which has a separate cavity for each conductor structure 92, so that each conductor structure 92 is embedded in a separate plastic casing 96 during the injection moulding process, wherein in each case a connection area 98 remains free. After the injection moulding, the complete plugs can be separated from the frame 94.

In order to prevent wetness or other media infiltrating the connection between the conductor structures 92 and the plastic casing 96, before the injection moulding the lead frame 92 is plasma coated in the area 100 adjoining the exposed connection areas 98 by impinging this area 100 of the lead frame 92 with a plasma beam and a precursor. For the complete plug, the layer produced in this way guarantees a connection between the conductor structure 92 and the plastic casing 96 which has long-term durability and is media-tight.

FIG. 5 shows a further exemplary embodiment of an injection-moulded component 110 with insert 112 in a schematic sectional view. The insert 112 is a sensor having a sensor area 114 arranged on an outer face of the injection-moulded component 110, via which the sensor 112 can measure a property of the surroundings, for example the temperature or the brightness. The sensor 112 is embedded by means of injection moulding in a plastic casing 116 which protects the electronics of the sensor 112 from environmental influences. In order to prevent infiltration of the connection between the sensor 112 and the plastic casing 116 from the side of the sensor area 114, before the injection moulding the sensor 112 is plasma coated in the area 118 adjoining the sensor area 114 by impinging this area 118 with a plasma beam and a precursor. The layer produced in this way guarantees a connection between the sensor 112 and the plastic casing 116 which has long-term durability and is media-tight.

Shear tension tests were carried out according to DIN EN 1465 in order to examine the media-tightness of the connection between a metal insert and the overmoulded plastic produced using the previously described method.

For this purpose, metal samples consisting of different materials (DC04 steel, 1.4301 stainless steel, 1.4031 polished stainless steel, 6016 aluminium) were produced and in the injection moulding process were overmoulded in certain areas with polyamide 6 having a 30% glass fibre proportion (PA6 GF30) or with polybutylene terephthalate (PBT). The sample geometry in each case corresponded to DIN EN 1465.

A share of the metal samples was impinged with an atmospheric plasma beam and with γ-methacryloxypropyltrimethoxysilane as the precursor according to the previously described method before the overmoulding took place; another share of the metal samples remained untreated for comparison.

Shear tension tests were subsequently carried out on the partly overmoulded metal samples according to DIN EN 1465.

FIG. 6 shows a diagram with the results of the shear tension tests on the partly overmoulded metal samples which were impinged with an atmospheric plasma beam and with γ-methacryloxypropyltrimethoxysilane according to the previously described method before the overmoulding took place. As the diagram shows, good tensile shearing strengths were obtained throughout.

In contrast, the comparison samples without plasma treatment and precursor impingement came apart straightaway after the injection moulding process or as soon as very low force loads were applied (tensile shearing strengths<1 MPa).

In addition, some of the metal samples impinged with the atmospheric plasma beam and γ-methacryloxypropyltrimethoxysilane and overmoulded with PA6 GF30 were aged before carrying out the shear tension tests, in order to test the long-term durability and media-tightness of the connection between the insert and the plastic.

FIG. 7 shows a diagram with the results of these shear tension tests. The left side of the diagram shows the results for overmoulded metal samples consisting of steel (from left to right) without ageing, after carrying out the pressure cooker test (using water with 15% common salt (NaCl) and 0.15% hydrochloric acid (HCl) instead of pure water) and after ageing for four weeks in a 5% aqueous NaCl solution. The right side of the diagram shows the results for overmoulded metal samples consisting of stainless steel (from left to right) without ageing, after carrying out the pressure cooker test, after ageing for four weeks in a 5% aqueous NaCl solution, after storing for two weeks in ethanol and after storing for two weeks in engine oil.

The results show that even after the different ageing processes good tensile shearing strengths were obtained throughout. Hence, the tests prove that the described method for producing an injection-moulded component produces a connection between the (metal) insert and the overmoulded plastic which has long-term durability and is media-tight. Particularly good results were obtained in particular using functionalised organosilicon precursors like γ-methacryloxypropyltrimethoxysilane.

Thus, using the previously described method for producing an injection-moulded component with insert, injection-moulded components can be produced which have long-term durability and are media tight and which are particularly suitable for use in an environment which is wet or contains solvents, in particular in a vehicle, such as in a motor vehicle or in an aircraft.

1. A method for producing an injection-moulded component with an insert comprising:
providing the insert with an inorganic surface,
wherein the insert is at least partly overmoulded in an injection moulding process, and
wherein an area of the inorganic surface of the insert, which area is overmoulded during the injection moulding process, is at least in certain areas coated prior to being overmoulded by impinging the inorganic surface with an atmospheric plasma beam and a precursor, and wherein an organosilicon-functionalized precursor is used as the precursor.

2. The method according to claim 1, wherein the insert is only partly overmoulded in the injection moulding process, so that an area of the insert is exposed after the injection moulding process.

3. The method according to claim 1, wherein the inorganic surface is a metal surface, a glass surface, or a ceramic surface.

4. The method according to claim 1, wherein the insert is an electrical component to be overmoulded.

5. The method according to claim 1, wherein a plasma nozzle generates the atmospheric plasma beam, wherein the plasma nozzle has a nozzle opening, out of which the plasma beam emerges in operation.

6. The method according to claim 1, wherein the atmospheric plasma beam is generated by means of an arc-like discharge in a working gas, wherein the arc-like discharge is generated by applying a high-frequency high voltage between electrodes.

7. The method according to claim 1, wherein the precursor is fed into the plasma beam.

8. (canceled)

9. The method according to claim 1, wherein the insert is overmoulded with a thermoplastic synthetic material.

10. An injection-moulded component comprising an insert, wherein the insert has an at least partly overmoulded, inorganic surface,
wherein a layer applied by plasma coating is arranged at least in certain areas between the inorganic surface and an overmoulded plastic.

11. The injection-moulded component according to claim 10, wherein the insert is only partly overmoulded, so that an area of the insert is exposed.

12. The injection-moulded component according to claim 10, wherein the insert is an electrical component comprising at least one of an overmoulded plug element, an overmoulded sensor, or an overmoulded conductor configuration.

13. The injection-moulded component according to claim 10, wherein the injection-moulded component is designed for application in an environment which is wet or contains solvents.

14. A method of using the injection-moulded component according to claim 10, the method comprising applying the injection-moulded component in an environment which is wet and contains solvents.

15. The method according to claim 4, wherein the electrical component comprises at least one of a plug element, a sensor, or a conductor structure.

16. The method according to claim 4, wherein the electrical component is a lead frame.

17. The method according to claim 9, wherein the thermoplastic synthetic material comprises at least one of polyamide, polybutylene terephthalate, polyethylene terephthalate, polycarbonate, or a liquid crystal polymer.

18. The method according to claim 1, wherein the insert is overmoulded with a thermosetting plastic.

19. The method according to claim 18, wherein the thermosetting plastic comprises polyurethane or epoxy resin.

20. The method according to claim 13, wherein the environment is a motor vehicle or an aircraft.
